(19) United States
(12) Patent Application Publication
(10) Pub. No.: US 2018/0176851 A1
(43) Pub. Date: Jun. 21, 2018

(54) METHOD AND DEVICE FOR TRANSMITTING/RECEIVING DATA IN MESH NETWORK USING BLUETOOTH

(71) Applicant: LG ELECTRONICS INC., Seoul (KR)

(72) Inventors: Jinkwon LIM, Seoul (KR); Younghwan KWON, Seoul (KR); Jingu CHOI, Seoul (KR); Taeyoung SONG, Seoul (KR)

(73) Assignee: LG Electronics Inc., Seoul (KR)

(21) Appl. No.: 15/569,994

(22) PCT Filed: Apr. 4, 2016
(86) PCT No.: PCT/KR2016/003469

§ 371 Date: Oct. 27, 2017

Related U.S. Application Data
(60) Provisional application No. 62/154,741, filed on Apr. 30, 2015.
(60) Provisional application No. 62/203,871, filed on Aug. 11, 2015.

(51) Int. Cl. H04W 40/24; H04W 68/00; H04W 76/10; H04W 84/18; H04W 88/04

(52) U.S. Cl. CPC H04W 40/24; H04W 68/00; H04W 4/80; H04W 84/18; H04W 88/04; H04W 76/10

(57) ABSTRACT

The present invention relates to a method and a device for a relay device changing a relay role in a Bluetooth mesh network. A method and a device is provided, according to the present invention, wherein a first message is received from a first device, the first message comprising first capability information indicating the capability of the first device, and the first capability information is compared with second capability information indicating the capability of a relay device, and on the basis of the comparison result, whether the first device will perform a relay role is decided, and a notification message comprising the decision result is transmitted to at least one device connected with the relay device.

### TECHNICAL FIELD

The present invention relates to a method and apparatus for transmitting and receiving data in a mesh network using the Bluetooth which is a short distance technique in wireless communication systems, and more particularly, to a method and apparatus for transmitting data to a destination through a relay node in a Bluetooth mesh network.

### BACKGROUND ART

Bluetooth is an NFC technology standard allowing various devices to be wirelessly connected in a near field to exchange data. If two devices attempt to perform wireless communication using Bluetooth communication, a user may perform a procedure for discovering a Bluetooth device with which he or she wants to communicate and requesting a connection. In the present invention, the device may refer to equipment or an apparatus.

In this case, the user may discover a Bluetooth device according to a Bluetooth communication method intended to be used using the Bluetooth device, and subsequently perform a connection.

The Bluetooth communication method may be classified as a BR/EDR method and an LE method. The BR/EDR method may be termed Bluetooth Classic. The Bluetooth Classic method includes a Bluetooth technology led from Bluetooth 1.0 and a Bluetooth technology using an enhanced data rate (EDR) supported by Bluetooth 2.0 or a subsequent version.

A Bluetooth low energy (LE) technology applied, starting from Bluetooth 4.0, may stably provide information of hundreds of kilobytes (KB) at low power consumption. Such a Bluetooth low energy technology allows devices to exchange information with each other by utilizing an attribute protocol. The Bluetooth LE method may reduce energy consumption by reducing overhead of a header and simplifying an operation.

Among the Bluetooth devices, some products do not have a display or a user interface. Complexity of connection, management, control, and disconnection among various types of Bluetooth devices and Bluetooth device employing similar technologies has increased.

Bluetooth supports a high speed at relatively low power consumption and at relatively low cost. However, since the transmission distance of Bluetooth is limited to a maximum of 100 m, Bluetooth is suitable for being used within a limited space.

### DISCLOSURE

### Technical Problem

An object of the present invention is to provide a method and apparatus for transmitting and receiving data using a Bluetooth Low Energy (LE) technique.

In addition, another object of the present invention is to provide a method for configuring a role of a relay device when a mesh network is formed using the Bluetooth.

In addition, still another object of the present invention is to provide a method for changing a role of data relay between devices in a mesh network using the Bluetooth.

In addition, still another object of the present invention is to provide a method for configuring a role of a relay by comparing capabilities between devices when a mesh network is formed using the Bluetooth.

In addition, still another object of the present invention is to provide a method for configuring a device proper for a relay of data as a relay device by comparing capabilities between devices when a mesh network is formed using the Bluetooth.

In addition, still another object of the present invention is to provide a method for decreasing traffic and preventing a data collision between delay devices by configuring a device proper for a relay of data as a relay device and other device not to relay by comparing capabilities between devices when a mesh network is formed using the Bluetooth.

The technical objects to attain in the present invention are not limited to the above-described technical objects and other technical objects which are not described herein will become apparent to those skilled in the art from the following description.

### Technical Solution

In order to solve the technical problem, the present invention proposes a method for changing a relay role performed by a relay device in a mesh network of Bluetooth including receiving a first message including first capability information indicating a capability of a first device from the first device; comparing the first capability information with second capability information indicating a capability of the relay device; determining whether the first device performs a relay role based on the comparison result; and transmitting a notification message including the comparison result to at least one device connected with the relay device.

In addition, the present invention further includes transmitting a second message including the second capability information to the second device.

In addition, in the present invention, the first message and the second message are transmitted through a data channel.

In addition, in the present invention, each of the first message and the second message further includes a channel ID indicating the data channel.

In addition, in the present invention, the first message and the second message are transmitted through an attribute protocol.

In addition, in the present invention, the first message is transmitted through an advertising channel.

In addition, the present invention further includes receiving a termination message indicating a termination of a relay role of the relay device from the first device, when the first device performs the relay role.

In addition, the present invention further includes a connection termination procedure with the at least one device.

In addition, in the present invention, each of the first capability information and the second capability information includes at least one of reception signal strength, battery remains information, transmission power information or a reception power information.

In addition, the present invention provides a method for performing a relay role performed by a first device in a mesh network of Bluetooth including transmitting a first message including first capability information indicating a capability of the first device to a relay device performing a relay role; receiving a second message including second capability information indicating a capability of the relay device from the relay device; comparing the first capability information with the second capability information; and determining whether the first device performs a relay role based on the comparison result.

In addition, the present invention further includes transmitting a termination message indicating a termination of a relay role of the relay device to the relay device, when the first device performs the relay role.

In addition, the present invention further includes performing a connection with at least one device which was connected with the relay device.

In addition, in the present invention, performing the connection includes: receiving an advertising message from the at least one device; and transmitting a connection request message to the at least one device based on the advertising message.

In addition, in the present invention, each of the first capability information and the second capability information includes at least one of reception signal strength, battery remains information, transmission power information or a reception power information.

In addition, the present invention provides a device including a communication unit for communicating with a wired or wireless signal with exterior; and a processor functionally connected with the communication unit, wherein the processor is configured to perform: receiving a first message including first capability information indicating a capability of a first device from the first device, comparing the first capability information with second capability information indicating a capability of the relay device, determining whether the first device performs a relay role based on the comparison result, transmitting a notification message including the comparison result to at least one device connected with the relay device.

### Technical Effects

According to a method for changing a relay role performed by a relay device in a mesh network of the Bluetooth according to an embodiment of the present invention, there is an effect of forming a meth network for a data relay efficiently.

In addition, the present invention has an effect of transmitting data to a long distance efficiently by configuring devices performing a relay role by comparing capabilities between devices when a mesh network is formed using the Bluetooth.

In addition, the present invention has an effect of decreasing traffic, the number of hops required to transmit data and data collision by configuring devices performing a relay role by comparing capabilities between devices when a mesh network is formed using the Bluetooth.

In addition, the present invention has an effect of preventing data to be transmitted with infinite loop by decreasing the number of delay devices by configuring devices performing a relay role by comparing capabilities between devices when a mesh network is formed using the Bluetooth.

The technical objects in the present invention are not limited to the above-described technical objects and other technical objects which are not described herein will become apparent to those skilled in the art from the following description.

### DESCRIPTION OF DRAWINGS

FIG. 1 is a schematic diagram showing an example of a wireless communication system using a Bluetooth LE technology to which the present invention may be applied.

FIG. 2 shows an example of an internal block diagram of a device to which the present invention may be applied.

FIG. 3 shows an example of Bluetooth LE topology.

FIG. 4 is a diagram showing an example of Bluetooth communication architecture to which the present invention may be applied.

FIG. 5 is a diagram showing an example of the structure of a profile based on the generic attribute profile (GATT) of Bluetooth LE.

FIG. 6 and FIG. 7 are schematic diagrams illustrating an example of a Bluetooth mesh network to which the present invention may be applied.

FIG. 8 is a diagram showing an example of the protocol stack of a Bluetooth mesh network to which the present invention may be applied.

FIG. 9 is a flowchart illustrating an example of a method for a device to join a Bluetooth mesh network to which the present invention may be applied.

FIG. 10 is a flowchart illustrating an example of a bearer establishment procedure based on an advertisement to which the present invention may be applied.

FIG. 11 and FIG. 12 are flowcharts illustrating an example of an operation of a relay device in a Bluetooth mesh network to which the present invention may be applied.

FIG. 13 and FIG. 14 are flowcharts illustrating an example of an operation of an edge device in a Bluetooth mesh network to which the present invention may be applied.

FIG. 15 is a flowchart illustrating an example of a method for changing a relay role between devices in a Bluetooth mesh network to which the present invention may be applied.

FIG. 16 and FIG. 17 are diagrams illustrating an example of a method for comparing capabilities between devices and a message format in a Bluetooth mesh network to which the present invention may be applied.

FIG. 18 and FIG. 19 are diagrams illustrating another example of a method for comparing capabilities between devices and a message format in a Bluetooth mesh network to which the present invention may be applied.

FIG. 20 is a flowchart illustrating an example for notifying a change of the relay role to devices in a Bluetooth mesh network to which the present invention may be applied.

FIG. 21 is a diagram illustrating an example that the method for changing relay role in a mesh network is applied in real life to which the present invention may be applied.

### BEST MODE FOR INVENTION

The aforementioned objects, features and advantages of the present invention will become more apparent through the following detailed description related to the accompanying drawings. Hereinafter, the embodiments of the present invention will be described with reference to the accompanying drawings, in which the same reference numbers refer to the same elements throughout the specification. In describing the present invention, a detailed description of the known functions and constitutions related to the present invention will be omitted if it is deemed to make the gist of the present invention unnecessarily vague.

Hereinafter, a method and apparatus related to the present invention will be described in detail with reference to the accompanying drawings. The suffixes of elements used in the following description, such as “module” and “unit”, are assigned or interchangeably used by taking into consideration only the easy of the writing of the specification, but they in themselves do not have different meanings or roles.

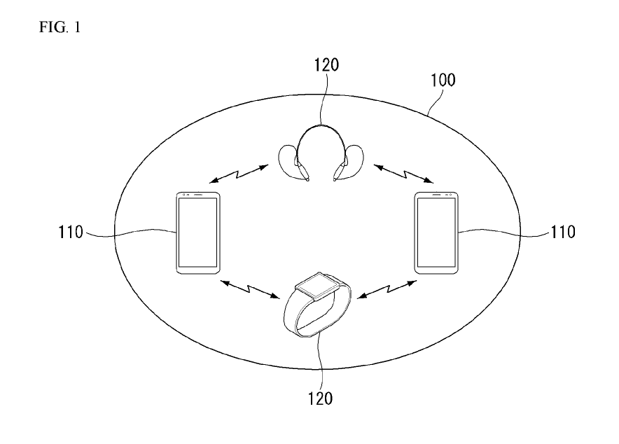

FIG. 1 is a schematic diagram showing an example of a wireless communication system using a Bluetooth LE technology to which the present invention may be applied.

A wireless communication system 100 includes at least one server device 120 and at least one client device 110.

The server device and the client device perform Bluetooth communication using a Bluetooth low energy (BLE) technology.

First, compared with a Bluetooth basic rate/enhanced data rate (BR/EDR), the BLE technology has a relatively small duty cycle, may be produced at low cost, and significantly reduce power consumption through a low data rate, and thus, it may operate a year or longer when a coin cell battery is used.

Furthermore, in the BLE technology, an inter-device connection procedure is simplified and a packet size is designed to be small compared with the Bluetooth BR/EDR technology.

In the BLE technology, (1) the number of RF channels is forty, (2) a data rate supports 1 Mbps, (3) topology has a scatternet structure, (4) latency is 3 ms, (5) a maximum current is 15 mA or lower, (6) output power is 10 mW (10 dBm) or less, and (7) the BLE technology is commonly used in applications such as a clock, sports, healthcare, sensors, device control, and the like.

The server device 120 may operate as a client device in a relationship with other device, and the client device may operate as a server device in a relationship with other device. That is, in the BLE communication system, any one device may operate as a server device or a client device, or may operate as both a server device and a client device if necessary.

The server device 120 may also be called as data service device, slave device, slave, server, conductor, host device, gateway, sensing device, monitoring device, first device, or the like, and the client device 110 may also be called as master device, master, client, member, sensor device, sink device, collector, second device, third device, and the like.

The server device and the client device correspond to major components of the wireless communication system, and the wireless communication system may include components other than the server device and the client device.

The server device refers to a device which receives data from the client device and provides data to the client device in response when a corresponding request is received from the client device, through direct communication with the client device.

Furthermore, in order to provide data information to the client device, the server device sends a notification message or an indication message to the client device in order to provide data information to the client device. Furthermore, the server device receives a confirmation message corresponding to the indication message from the client device.

Furthermore, in the process of transmitting and receiving notification, indication, and confirmation messages to and from the client device, the server device may provide data information to a user through a display unit or may receive a request input from the user through a user input interface.

Furthermore, in the process of transmitting and receiving message to and from the client device, the server device may read data from a memory unit or may write new data to the corresponding memory unit.

Furthermore, the single server device may be connected with a plurality of client devices, and may be easily re-connected with client devices using bonding information.

The client device 120 refers to a device which requests data information and data transmission from the server device.

The client device receives data through a notification message or an indication message from the server device, and when an indication message is received from the server device, the client device sends an acknowledgement message in response to the indication message.

Similarly, in the process of transmitting and receiving messages to and from the server device, the client device may also provide information to the user through a display unit or may receive an input from the user through a user input interface.

Furthermore, in the process of transmitting and receiving messages with the server device, the client device may read data from a memory unit or may write new data to the corresponding memory unit.

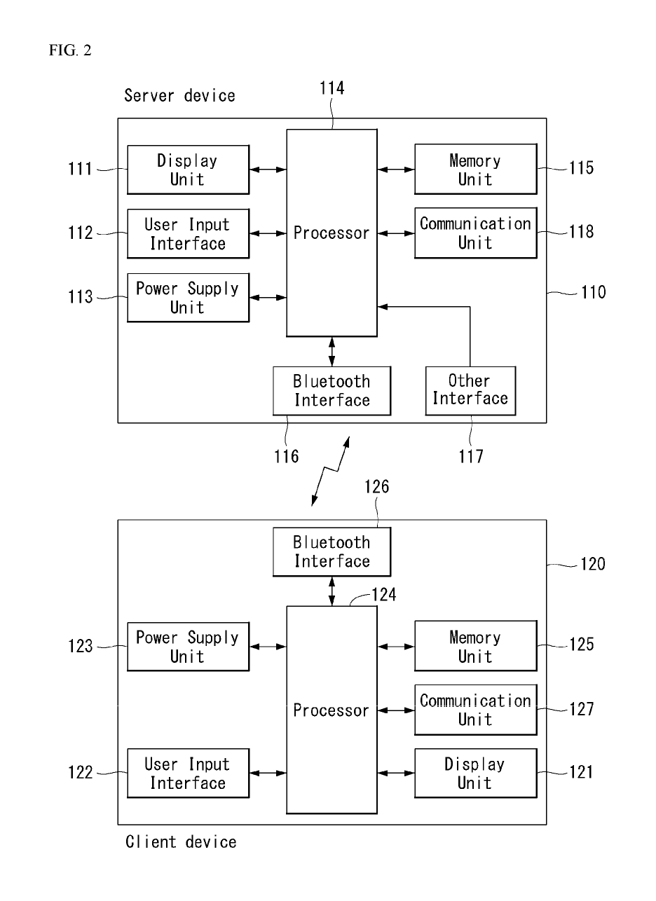

Hardware components such as the display units, the user input interfaces, and the memory units of the server device and the client device will be described in detail with reference to FIG. 2.

Furthermore, the wireless communication system may configure personal area networking (PAN) through the Bluetooth technology. For example, in the wireless communication system, a private piconet may be established between devices to quickly and safely exchange files, documents, and the like.

FIG. 2 shows an example of an internal block diagram of a device to which the present invention may be applied.

As illustrated in FIG. 2, a server device includes a display unit 111, a user input interface 112, a power supply unit 113, a processor 114, a memory unit 115, a Bluetooth interface 116, other interface 117, and a communication unit (or transceiver unit) 118.

The display unit 111, the user input interface 112, the power supply unit 113, the processor 114, the memory unit 115, the Bluetooth interface 116, other interface 117 and the communication unit 118 are functionally connected to perform a method proposed in this disclosure.

Furthermore, the client device includes a display unit 121, a user input interface 122, a power supply unit 123, a processor 124, a memory unit 125, a Bluetooth interface 126, and a communication unit (or transceiver unit) 128.

The display unit 121, the user input interface 122, the power supply unit 123, the processor 124, the memory unit 125, the Bluetooth interface 126, other interface 127 and the communication unit 128 are functionally connected and perform methods proposed in the present invention.

The Bluetooth interface 116, 126 refers to a unit (or module) capable of transmitting data, such as a request/response, a command, a notification, an indication/confirmation message, between devices.

The memory unit 115, 126 is a unit implemented in various types of devices in which various types of data are stored.

The processor 114, 124 refers to a module controlling an overall operation of the server device or the client device, which controls requesting the transmission of a message through the Bluetooth interface and other interface and processing a received message.

The processor 114, 124 may also be called a controller, a control unit or the like.

The processor 114, 124 may include application-specific integrated circuits (ASICs), other chip sets, logic circuits and/or data processing units.

The processor 114, 124 controls the communication units so that they receive an advertising message from the server device, controls the communication unit so that it transmits a scan request message to the server device and receives a scan response message from the server device in response to the scan request, and controls the communication unit so that it transmits a connection request message to the server device in order to establish a Bluetooth connection with the server device.

Furthermore, after a Bluetooth LE connection is established through a connection procedure, the processor 114, 124 controls the communication units so that they read or write data using an attribute protocol from the server device

The memory unit 115, 125 may include read-only memory (ROM), random access memory (RAM), flash memory, a memory card, a storage medium and/or other storage devices.

The communication unit 118, 127 may include a baseband circuit for processing a wireless signal. If an embodiment is implemented in software, the aforementioned technology may be implemented as a module (process, function, etc.) performing the aforementioned function. The module may be stored in the memory unit and executed by the processor.

The memory unit 115, 125 may be present inside or outside the processor 114, 124 and may be connected to the processor 114, 124 through various well-known units.

The display unit 111, 121 refers to a module providing status information of the device, message exchange information and the like to a user through a screen.

The power supply unit 113, 123 refers to a module receiving external power or internal power and supplying power necessary for the operations of the components under the control of the controller 114, 124.

As discussed above, the BLE technology, has a relatively small duty cycle and power consumption may be significantly reduced through a low data rate, and thus, the power supply unit may supply power required for operations of the components even with small output power (10 mW (10 dBm) or less).

The user input interface 112, 122 refers to a module providing user input, such as a screen button, to the controller to enable a user to control the operation of the device.

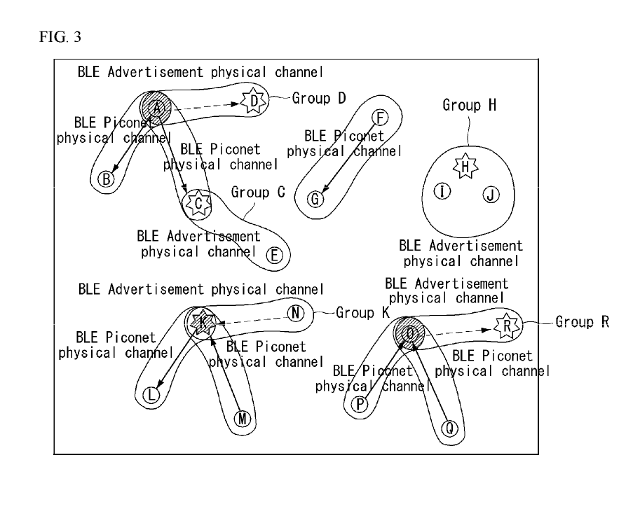

FIG. 3 is a view illustrating an example of the BLE topology.

Referring to FIG. 3, a device A corresponds to a master in a piconet (piconet A, the shaded portion) having a device B and a device C as slaves.

In this case, the piconet refers to an aggregation of devices in which any one of them is a mater and the other devices occupy a shared physical channel connected to the master device.

The BLE slaves do not share a common physical channel with the master. Each of the slaves communicates with the master trough a separate physical channel. There is another piconet (piconet F) having a master device F and a slave device G.

A device K is present in a scatternet K. In this case, the scatternet refers to a group of piconets connected to other piconets.

The device K is a master of a device L and a slave of a device M.

A device O is also in the scatter net O. The device O is a slave of a device P and a slave of a device Q.

As illustrated in FIG. 2, five different device groups are present.

1. Device D is an advertiser and device A is an initiator (group D).

2. Device E is a scanner and Device C is an advertiser (group C).

3. Device H is an advertiser, and devices I and J are scanners (group H).

4. Device K is also an advertiser, and device N is an initiator (group K).

5. Device R is an advertiser, and device O is an initiator (group R).

The devices A and B use a single BLE piconet physical channel.

The devices A and C use another BLE piconet physical channel.

In group D, the device D advertises using an advertising event connectable in an advertising physical channel, and the device A is an initiator. The device A may establish a connection with the device D and add a device to the piconet A.

In group C, the device C advertises on an advertising physical channel using a certain type of an advertising event captured by the scanner device E.

The group D and the group C may use different advertising physical channels or different times in order to avoid collision.

In the piconet F, a single physical channel is present. The devices F and G use a single BLE piconet physical channel. The device F is a master, and the device G is a slave.

In group H, a single physical channel is present. The devices H, I, and J use a single BLE advertising physical channel. The device H is an advertiser, and the devices I and J are scanners.

In the scatternet K, the devices K and L use a single BLE piconet physical channel. The devices K and M use another BLE piconet physical channel.

In group K, the device K advertises using an advertising event connectable on an advertising physical channel, and the device N is an initiator. The device N may establish a connection with the device K. In this case, the device K may be a slave of two devices and a master of one device at the same time.

In the scatternet O, the devices O and P use a single BLE piconet physical channel. The devices O and Q use another BLE piconet physical channel.

In group R, the device R advertises using an advertising event connectable on an advertising physical channel, and the device O is an initiator. The device O may establish a connection with the device R. In this case, the device O may be a slave of two devices and a master of one device at the same time.

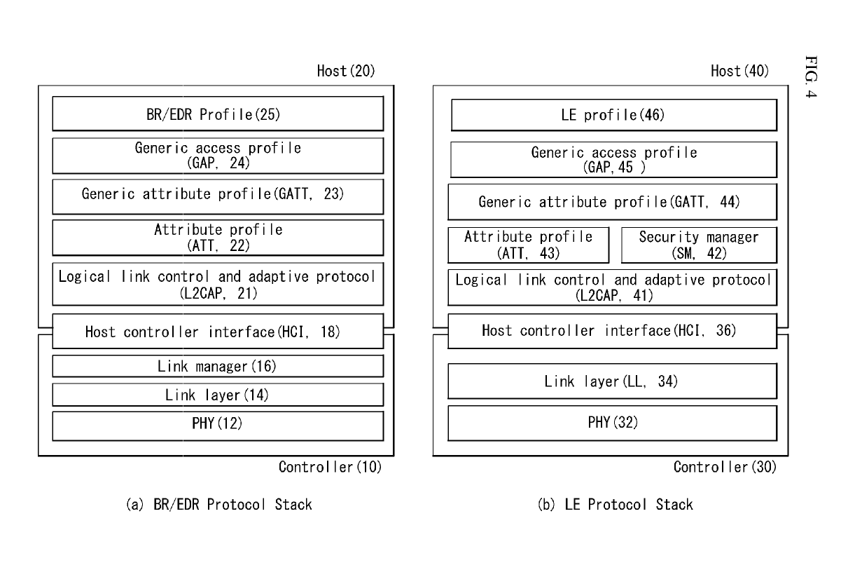

FIG. 4 is a diagram showing an example of Bluetooth communication architecture to which the present invention may be applied.

Referring to FIG. 4, (a) of FIG. 4 illustrates an example of a protocol stack of a Bluetooth basic rate (BR)/enhanced data rate (EDR), and (b) of FIG. 4 illustrates an example of a protocol stack of BLE.

In detail, as illustrated in (a) of FIG. 4, the Bluetooth BR/EDR protocol stack may include an upper controller stack 10 and a lower host stack 20 with respect to a host controller interface (HCI) 18.

The host stack (or host module) 20 refers to hardware for transmitting or receiving a Bluetooth packet to and from a wireless transceiver module receiving a Bluetooth signal of 2.4 GHz, and is connected to a Bluetooth module, the controller stack 10, to control the Bluetooth module and performs an operation.

The host stack 20 may include a BR/EDR PHY layer 12, a BR/EDR baseband layer 14, and a link manager 16.

The BR/EDR PHY layer 12 is a layer transmitting and receiving a 2.4 GHz wireless signal. If Gaussian frequency shift keying (GFSK) modulation is used, the BR/EDR PHY layer 12 may transmit data by hopping 79 RF channels.

The BR/EDR baseband layer 14 functions to transmit a digital signal, select a channel sequence hopping 1400 times per second, and transmit a time slot having a length of 625 us for each channel.

The link manager layer 16 controls an overall operation (link setup, control and security) of a Bluetooth connection using a link manager protocol (LMP).

The link manager layer 16 may perform the following functions.
The link manager layer 16 may perform ACL/SCO logical transport, logical link setup, and control
Detach: The link manager layer 16 stops connection and informs a counterpart device about the reason for stopping connection.
The link manager layer 16 performs power control and role switch.
The link manager layer 16 performs a security (authentication, pairing and encryption) function.

The host controller interface layer 18 provides an interface between the host module and the controller module to allow the host to provide a command and data to the controller and allow the controller to provide an event and data to the host.

The host stack (or host module 20) includes a logical link control and adaptation protocol (L2CAP) 21, a security manager (SM) 22, an attribute protocol (ATT) 23, a generic attribute profile (GATT) 24, a generic access profile (GAP) 25, and a BR/EDR profile 26.

The logical link control and adaptive protocol (L2CAP) 21 may provide a two-way channel for transmitting data to a specific protocol or a profile.

The L2CAP 21 may multiplex various protocols and profiles provided by a Bluetooth higher position.

The L2CAP of the Bluetooth BR/EDR uses a dynamic channel, supports a protocol service multiplexer, retransmission, and a streaming mode, and provides segmentation and reassembly, per-channel flow control, and error control.

The generic attribute profile (GATT) 24 may operate as a protocol describing how the attribute protocol 23 is used when services are configured. For example, the generic attribute profile 24 may operate to define how the ATT attributes are grouped with services, and operate to describe features associated with the services.

Thus, the GATT 24 and the ATT 23 may use features in order to describe the status and services of a device and describe how the features are related and used.

The attribute protocol (ATT) 23 and profile 26 define a service (profile) using the Bluetooth BR/EDR and define an application protocol for exchanging data thereof, and the generic access profile (GAP) 25 defines a scheme for discovering and connecting devices and providing information to a user, and provides privacy.

As illustrated in (b) of FIG. 4, the Bluetooth LE protocol stack includes a controller stack 30 operable to process a wireless device interface whose timing is important, and a host stack 40 operable to process high level data.

First, the controller stack 30 may be implemented using a communication module that may include a Bluetooth wireless device, for example, a processor module that may include a processing device, such as a microprocessor.

The host stack may be implemented as part of an OS that operates on a processor module or may be implemented as the instantiation of a package on the OS.

In some examples, the controller stack and the host stack may operate or may be executed on the same processing device within a processor module.

The controller stack 30 includes a physical layer (PHY) 32, a link layer (LL) 34, and a host controller interface (HCI) 36.

The physical layer (PHY) (wireless transceiver module) 32 is a layer for transmitting and receiving a 2.4 GHz wireless signal, and uses Gaussian frequency shift keying (GFSK) modulation and a frequency hopping technique including 40 RF channels.

The link layer (LL) 34 serving to transmit or receive a Bluetooth packet provides a function of generating a connection between devices after performing an advertising and scanning function using three advertising channels, and exchanging data packets of a maximum of 257 bytes through thirty-seven data channels.

The host stack may include a generic access profile (GAP) 40, a logical link control and adaptation protocol (L2CAP) 41, a security manager (SM) 42, an attribute protocol (ATT) 43, a generic attribute profile (GATT) 44, a generic attribute profile (GAP) 45, and an LE profile 46. However, the host stack 40 is not limited thereto and may include various protocols and profiles.

The host stack multiplexes various protocols and profiles provided from a Bluetooth higher position using the L2CAP.

First, the L2CAP 41 may provide a single two-way channel for transmitting data to a specific protocol or profile.

The L2CAP 41 may operate to multiplex data between higher layer protocols, segment and reassemble packages, and to manage the transmission of multicast data.

Three fixed channels (one for a signaling channel (CH), one for a security manager, and one for an attribute protocol) are used in BLE.

Meanwhile, the basic rate/enhanced data rate (BR/EDR) uses a dynamic channel and supports a protocol service multiplexer, retransmission, streaming mode, and the like.

The SM 42 is a protocol for certifying a device and providing a key distribution.

The ATT 43 defines a rule for accessing data of a counterpart device by a server-client structure. The ATT 43 includes six types of messages (request, response, command, notification, indication, and confirmation) as follows.
Request and Response message: a request message is a message for a client device to request specific information from a server device, and a response message, as a response message with respect to the request message, refers to a message transmitted from the server device to the client device.
Command message: a message transmitted from the client device to the server device in order to indicate a command of a specific operation. The server device does not transmit a response with respect to the command message to the client device.
Notification message: a message transmitted from the server device to the client device in order to provide notification of an event or the like. The client device does not transmit a confirmation message with respect to the notification message to the server device.
Indication and confirmation message: a message transmitted from the server device to the client device in order to provide notification of an event or the like. Unlike the notification message, the client device transmits a confirmation message regarding the indication message to the server device.

In the present invention, when the GATT profile using the attribute protocol (ATT) 43 requests long data, a value regarding a data length is transmitted to allow a client to clearly know the data length, and a characteristic value may be received from a server using a universal unique identifier (UUID).

The generic access profile (GAP) 45, a layer newly implemented for the Bluetooth LE technology, is used to select a role for communication between Bluetooth LED devices and to control how a multi-profile operation takes place.

Furthermore, the generic access profile (GAP) 45 is mainly used for device discovery, connection generation, and security procedure part, defines a scheme for providing information to a user, and defines types of attributes as follows.
Service: It defines a basic operation of a device by a combination of behaviors related to data
Include: It defines a relationship between services
Characteristics: It is a data value used in a server
Behavior: It is a format that may be read by a computer defined by a UUID (value type).

The LE profile 46, profiles dependent upon GATT, is mainly applied to a BLE device. The LE profile 46 may include, for example, Battery, Time, FindMe, Proximity, Time, Object Delivery Service, and the like, and details of GATT-based Profiles are as follows.
Battery: Battery information exchanging method
Time: Time information exchanging method
FindMe: Provision of alarm service according to distance
Proximity: Battery information exchanging method

Time: Time information exchanging method

The generic attribute profile (GATT) 44 may operate as a protocol describing how the attribute protocol (ATT) 43 is used when services are configured. For example, the GATT 44 may operate to define how ATT attributes are grouped together with services and operate to describe features associated with services.

Thus, the GATT 44 and the ATT 43 may use features in order to describe status and services of a device and describe how the features are related and used.

Hereinafter, procedures of the Bluetooth low energy (BLE) technology will be briefly described.

The BLE procedure may be classified as a device filtering procedure, an advertising procedure, a scanning procedure, a discovering procedure, and a connecting procedure.

Device Filtering Procedure

The device filtering procedure is a method for reducing the number of devices performing a response with respect to a request, indication, notification, and the like, in the controller stack.

When requests are received from all the devices, it is not necessary to respond thereto, and thus, the controller stack may perform control to reduce the number of transmitted requests to reduce power consumption.

An advertising device or scanning device may perform the device filtering procedure to limit devices for receiving an advertising packet, a scan request or a connection request.

In this case, the advertising device refers to a device that transmits an advertising event, that is, a device that performs an advertisement, and it is also called an advertiser.

The scanning device refers to a device performing scanning, that is, a device transmitting a scan request.

In the BLE, in a case in which the scanning device receives some advertising packets from the advertising device, the scanning device should transmit a scan request to the advertising device.

However, in a case in which a device filtering procedure is used so a scan request transmission is not required, the scanning device may disregard the advertising packets transmitted from the advertising device.

Even in a connection request process, the device filtering procedure may be used. In a case in which device filtering is used in the connection request process, it is not necessary to transmit a response with respect to the connection request by disregarding the connection request

Advertising Procedure

The advertising device performs an advertizing procedure to perform undirected broadcast to devices within a region.

In this case, omni-directional broadcast refers to broadcast in all (every) directions, rather than broadcast in a specific direction.

In contrast, directional broadcast refers to broadcast in a specific direction. Omni-directional broadcast is generated between an advertising device and a device in the listening state (hereinafter, referred to as a “listening device”).

The advertising procedure is used to establish a Bluetooth connection with an initiating device nearby.

Or, the advertising procedure may be used to provide periodical broadcast of user data to scanning devices performing listening in an advertising channel.

In the advertising procedure, all the advertisings (or advertising events) are broadcast through an advertising physical channel.

The advertising devices may receive scan requests from listening devices performing listening to obtain additional user data from advertising devices. The advertising devices transmit responses with respect to the scan requests to the devices which have transmitted the scan requests, through the same advertising physical channels as the advertising physical channels in which the scan requests have been received.

Broadcast user data sent as part of advertising packets are dynamic data, while the scan response data is generally static data.

The advertising device may receive a connection request from an initiating device on an advertising (broadcast) physical channel. If the advertising device has used a connectable advertising event and the initiating device has not been filtered according to the device filtering procedure, the advertising device may stop advertising and enter a connected mode. The advertising device may start advertising after the connected mode.

Scanning Procedure

A device performing scanning, that is, a scanning device performs a scanning procedure to listen to undirected broadcasting of user data from advertising devices using an advertising physical channel.

In order to request additional user data from the advertising device, the scanning device transmits a scan request to the advertising device. The advertising device transmits a scan response, including additional user data requested by the scanning device, through an advertising physical channel in response to the scan request.

The scanning procedure may be used while being connected to other BLE device in the BLE piconet.

If the scanning device is in an initiator mode in which the scanning device may receive an advertising event and initiates a connection request. The scanning device may transmit a connection request to the advertising device through the advertising physical channel to start a Bluetooth connection with the advertising device.

When the scanning device transmits a connection request to the advertising device, the scanning device stops the initiator mode scanning for additional broadcast and enters the connected mode

Discovering Procedure

Devices available for Bluetooth communication (hereinafter, referred to as “Bluetooth devices”) perform an advertising procedure and a scanning procedure in order to discover devices located nearby or in order to be discovered by other devices within a given area.

The discovering procedure is performed asymmetrically. A Bluetooth device intending to discover other device nearby is termed a discovering device, and listens to discover devices advertising an advertising event that may be scanned. A Bluetooth device which may be discovered by other device and available to be used is termed a discoverable device and positively broadcasts an advertising event such that it may be scanned by other device through an advertising (broadcast) physical channel.

Both the discovering device and the discoverable device may have already been connected with other Bluetooth devices in a piconet.

Connecting Procedure

A connecting procedure is asymmetrical, and requests that, while a specific Bluetooth device is performing an advertising procedure, another Bluetooth device should perform a scanning procedure.

That is, an advertising procedure may be aimed, and as a result, only one device may response to the advertising. After a connectable advertising event is received from an advertising device, a connecting request may be transmitted to the advertising device through an advertising (broadcast) physical channel to initiate connection.

Hereinafter, operational states, that is, an advertising state, a scanning state, an initiating state, and a connection state, in the BLE technology will be briefly described.

Advertising State

A link layer (LL) enters an advertising state according to an instruction from a host (stack). In a case in which the LL is in the advertising state, the LL transmits an advertising packet data unit (PDU) in advertising events.

Each of the advertising events include at least one advertising PDU, and the advertising PDU is transmitted through an advertising channel index in use. After the advertising PDU is transmitted through an advertising channel index in use, the advertising event may be terminated, or in a case in which the advertising device may need to secure a space for performing other function, the advertising event may be terminated earlier

Scanning State

The LL enters the scanning state according to an instruction from the host (stack). In the scanning state, the LL listens to advertising channel indices.

The scanning state includes two types: passive scanning and active scanning. Each of the scanning types is determined by the host.

A separate time or advertising channel index for performing scanning is not defined.

In the scanning state, the LL listens to an advertising channel index for scan window duration. A scan interval is defined as an interval between start points of two continuous scan windows.

When there is no collision in scheduling, the LL should listen in order to complete all the scan intervals of the scan window as instructed by the host. In each scan window, the LL should scan other advertising channel index. The LL uses every available advertising channel index.

In the passive scanning, the LL only receives packets and cannot transmit any packet.

In the active scanning, the LL performs listening in order to be relied on an advertising PDU type for requesting advertising PDUs and advertising device-related additional information from the advertising device

Initiating State

The LL enters the initiating state according to an instruction from the host (stack).

When the LL is in the initiating state, the LL performs listening on advertising channel indices.

During the initiating state, the LL listens to an advertising channel index during the scan window interval

Connection State

When the device performing a connection state, that is, when the initiating device transmits a CONNECT_REQ_PDU to the advertising device or when the advertising device receives a CONNECT_REQ_PDU from the initiating device, the LL enters a connection state.

It is considered that a connection is generated after the LL enters the connection state. However, it is not necessary to consider that the connection should be established at a point in time at which the LL enters the connection state. The only difference between a newly generated connection and an already established connection is a LL connection supervision timeout value.

When two devices are connected, the two devices play different roles.

An LL serving as a master is termed a master, and an LL serving as a slave is termed a slave. The master adjusts a timing of a connecting event, and the connecting event refers to a point in time at which the master and the slave are synchronized.

Hereinafter, packets defined in a Bluetooth interface will be briefly described. BLE devices use packets defined as follows

Packet Format

The LL has only one packet format used for both an advertising channel packet and a data channel packet.

Each packet includes four fields of a preamble, an access address, a PDU, and a CRC.

When one packet is transmitted in an advertising physical channel, the PDU may be an advertising channel PDU, and when one packet is transmitted in a data physical channel, the PDU may be a data channel PDU.

Advertising Channel PDU

An advertising channel PDU has a 16-bit header and payload having various sizes.

A PDU type field of the advertising channel PDU included in the heater indicates PDU types defined in Table 1 below.

TABLE 1

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

Advertising PDU

The following advertising channel PDU types are termed advertising PDUs and used in a specific event.

ADV_IND: Connectable undirected advertising event

ADV_DIRECT_IND: Connectable directed advertising event

ADV_NONCONN_IND: Unconnectable undirected advertising event

ADV_SCAN_IND: Scannable undirected advertising event

The PDUs are transmitted from the LL in an advertising state, and received by the LL in a scanning state or in an initiating state.

Scanning PDU

The following advertising channel DPU types are termed scanning PDUs and are used in a state described hereinafter.

SCAN_REQ: Transmitted by the LL in a scanning state and received by the LL in an advertising state.

SCAN_RSP: Transmitted by the LL in the advertising state and received by the LL in the scanning state.

Initiating PDU

The following advertising channel PDU type is termed an initiating PDU.

CONNECT_REQ: Transmitted by the LL in the initiating state and received by the LL in the advertising state.

Data Channel PDU

The data channel PDU may include a message integrity check (MIC) field having a 16-bit header and payload having various sizes.

The procedures, states, and packet formats in the BLE technology discussed above may be applied to perform the methods proposed in this disclosure.

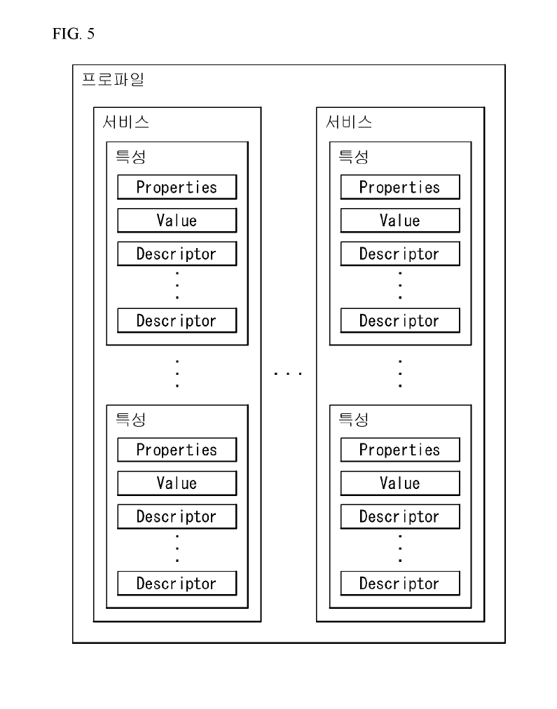

FIG. 5 is a diagram showing an example of the structure of a profile based on the generic attribute profile (GATT) of Bluetooth LE.

Referring to FIG. 5, a structure for exchanging profile data of BLE may be examined.

In detail, the GATT defines a method for exchanging data using a service between Bluetooth LE devices and a characteristic.

In general, a peripheral device (for example, a sensor device) serves as a GATT server, and has definition regarding a service and a characteristic.

In order to read or write data, a GATT client sends a data request to the GATT server, and every operation (transaction) is started by the GATT client and a response is received from the GATT server.

A GATT-based operational structure used in the Bluetooth LE may be a vertical structure as illustrated in FIG. 5 on the basis of a profile, a service, and a characteristic.

The profile includes one or more services, and the services may include one or more characteristics or other services.

The service functions to divide data into logical units and may include one or more characteristics or other services, each of the services has a 16-bit or 128-bit identifier called a universal unique identifier (UUID)).

The characteristic is the lowermost unit in the GATT-based operational structure. The characteristic includes only one data, and has a 16-bit or 128-bit UUID, similar to the service.

The characteristic is defined by values of various types of information, and in order to hold each piece of information, an attribute may be required for each piece of information. The characteristic may use several continuous attributes.

The attribute has four components and has meanings as follows.
handle: Address of attribute
Type: Type of attribute
Value: Value of attribute
Permission: Right to access attribute

In Bluetooth LE, however, link quality is variable in view of the characteristic of wireless transmission, and thus a shadow area exceeding a radio propagation distance may be generated in view of a one-to-one connection. Accordingly, in order to solve such problems, in Bluetooth, devices on which Bluetooth has been mounted may form a mesh network as a scheme for control through a hop connection between several devices.

The mesh network is described below.

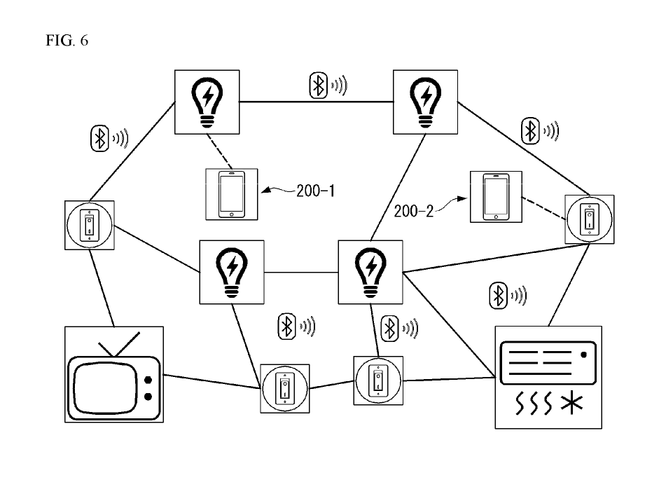

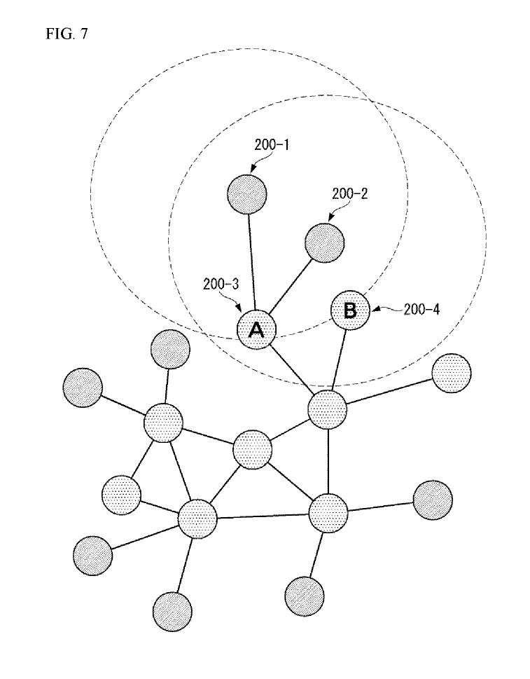

FIG. 6 and FIG. 7 are schematic diagrams illustrating an example of a Bluetooth mesh network to which the present invention may be applied.

As illustrated in FIG. 6 and FIG. 7, a mesh network refers to a network in which multiple devices are connected to each other like a mesh and may transmit and receive data over Bluetooth.

A Bluetooth mesh network technique is made up of several relay nodes 200-3 and 200-4 that relay messages between a source device 200-1 that transmits data and a destination device 200-2 that receives data.

Alternatively, the Bluetooth mesh network may be distinguished by edge nodes 200-1 and 200-2 and relay nodes 200-3 and 200-4.

Each node has a message cache of recently received messages. In the case that a received message is already existed in the message cache, the message is not relayed any longer.

However, in the case that a received message is not existed in the message cache, the message is relayed and stored in the message cache.

An edge node usually receives its power from a battery, and is in sleep state at normal times and may wake up for interaction or periodically.

The edge node may process a received message in the case that the following conditions are satisfied:
A message is not in the message cache.
A message is authenticated by a known network key.
The destination of a message is a unicast address of the edge node, a broadcast address or group address to which the edge node belongs.

A relay node is usually a device that receives main power, which is always awake and may transmit received data for other nodes.

The relay node may retransmit a received message to other nodes in the case that the following conditions are satisfied:
A message is not in the message cache.
A message is authenticated by a known network key.
The field (e.g., relay value) indicating whether to relay a message has a value that permits relaying.
The destination address is not a unicast address assigned for the relay node.

Bluetooth mesh networks may use either a flooding technique or a routing technique, depending on how to relay nodes 200-3 and 200-4 transmit data.

In the routing technique, the source device 200-1 transmits a message to a particular relay node, and the particular relay node, upon receiving the message, transmits the message based on information on another relay node or the destination device 200-2 to which the message is to be retransmitted.

The routing technique uses a broadcasting channel or point-to-point connection scheme so as to receive and retransmit messages.

In addition, a routing device that receives a message using the routing technique determines the best routing route(s) along which the message is to be transmitted to an intermediate device or a destination device, and decides which route to take to transmit the message based on a determined routing table.

However, in the routing technique, messages need to maintain their routing tables when they are transmitted. Thus, the routing technique becomes more complex and requires more memory as the number of messages increase. Also, the routing technique is less dynamic and more difficult to implement than the flooding technique, but offers good extensibility.

The flooding technique refers to a technique in which relay nodes receive a message and transmit it over the air via radio waves having the characteristic of propagating into the air in all directions.

That is, the source device 200-1 transmits a message to relay nodes 200-3 and 200-4 through broadcast channels, and the relay nodes that receive it transmit the message to neighboring relay nodes so that it is delivered to the destination device 200-2.

The flooding technique uses a broadcast channel to receive and retransmit messages, thus extending the transmission range of messages.

A mesh network using the flooding technique is a dynamic network. In the mesh network using the flooding technique, a device can receive and transmit (or retransmit) a message at any time as long as its density allows it.

The flooding technique is easy to implement, but may have extensibility issues arising from an extended network because messages are transmitted without directionality.

That is, in the mesh network using the flooding technique, when a device transmits a message, multiple devices receive the message and forward the received message to other devices.

To avoid this, the number of devices on the mesh network may be adjusted between 100 and 1,000, and the exact number of devices may be determined by a number of factors.

For example, the exact number of devices may be determined by network capacity, traffic load of data sources, network latency, reliability requirements, and so on.

In addition, unlike the routing technique, the flooding technique enables the transfer of a message easily without the cost of constructing a routing table, but increases network traffic because all relay devices 200-3 and 200-4 that receive the message retransmit it.

For example, as shown in FIG. 7, in the state that two edge nodes 200-1 and 200-2 are in connection with relay node A 200-3, in the case that a new relay node B 200-4 approaches in a connectable range of the two edge nodes 200-1 and 200-2, the two edge nodes 200-1 and 200-2 may be connected with the new relay node B 200-4.

However, if the relay node B 200-4 has better performance (e.g., RSSI, battery capacity, transmission and reception capability, etc.) of the relay node A 200-3, the two edge nodes 200-1 and 200-2 are not required to continue the connection with the relay node A 200-3.

As such, a plurality of relay devices A 200-3 which is not necessarily required in a message delivery in the floating technique is existed, and thus, there is a problem that a network traffic increases, and collision possibility of messages increases.

Accordingly, in order to solve the problem, the present invention proposes a method of changing the relay devices not required in a message delivery to a mode in which the relay operation is not performed.

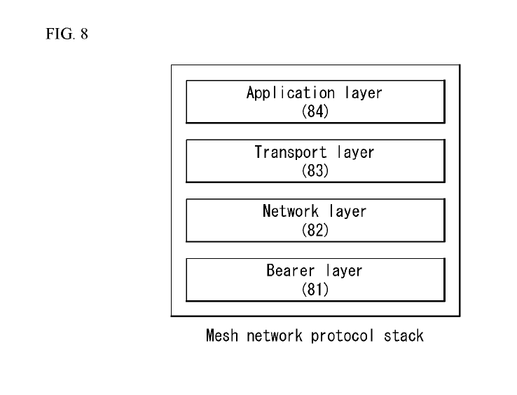

FIG. 8 is a diagram showing an example of the protocol stack of a Bluetooth mesh network to which the present invention may be applied.

Referring to FIG. 8, the protocol stack of the mesh network includes a bearer layer 81, a network layer 82, a transport layer 83 and an application layer 84.

The bearer layer 81 defines a method in which a message is transmitted between nodes. That is, in a mesh network, the bearer layer determines a bearer to which a message is transmitted.

A mesh network includes an advertising bearer and a GATT bearer for message transmission.

The network layer 82 defines a method of a message being transmitted to one or more nodes in a mesh network and the formats of network messages transmitted by the bearer layer 81.

Furthermore, the network layer 82 defines whether a message will be relayed or forwarded and a method of authenticating and encrypting network messages.

The transport layer 83 defines the encryption and authentication of application data by providing the confidentiality of an application message.

The application layer 84 defines a method and application Opcode and parameters relating how a higher layer application uses the transport layer 83.

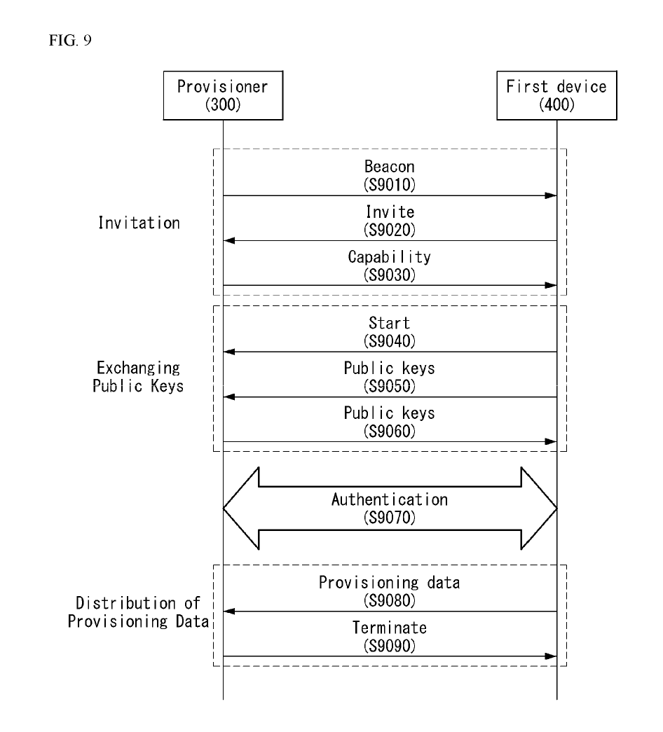

FIG. 9 is a flowchart illustrating an example of a method for a device to join a Bluetooth mesh network to which the present invention may be applied.

In order for a new device or a device that has not been provisioned to join a mesh network, the device must experience a provisioning procedure.

The provisioning procedure means a procedure for authenticating a non-authenticated device and providing basic information (e.g., a unicast address and various keys) for joining the mesh network.

That is, the provisioning procedure is a procedure of providing information so that a provisioner (a first device 300) in a mesh network joins the mesh network. The first device 300 may obtain the address of a network, keys, a device identifier and various types of information on which the first device operates as part of a mesh network through the provisioning procedure.

The provisioning procedure includes an invitation step, an exchanging public key step, an authentication step and a distribution-of-provisioning data step.

The provisioning procedure may be performed through various types of bearers. For example, the provisioning procedure may be performed by an advertising-based bearer, a mesh provisioning service-based bearer or a mesh-based bearer.

The advertising-based bearer is an essentially established bearer. The provisioning service-based bearer or the mesh-based bearer may be used for a provisioning procedure if the advertising-based bearer does not support the advertising-based bearer or provisioning data cannot be transmitted through the advertising-based bearer.

The provisioning service-based bearer means a bearer with which provisioning data is exchanged through the GATT Protocol of existing Bluetooth LE. The mesh-based bearer means a bearer with which provisioning data can be exchanged over a mesh network if the first device 300 and the second device 400 are not located in the distance where data can be directly exchanged.

A procedure of establishing the advertising-based bearer is described later.

After the bearer is established between the first device 300 and the second device 400, the first device 300 may be provisioned through the following provisioning procedure.

Invitation Step

The invitation step is started as the second device 400 scans the first device 300. The first device transmits a beacon message to the second device 400 (S9010). The beacon message includes the UUID of the first device 300.

The second device 400 that has scanned the first device 300 through the beacon message transmits an invite message to the first device 300 (S9020).

The invite message asks the first device 300 whether it performs a provisioning procedure. If the first device 300 does not want to perform the provisioning procedure, it neglects the invite message.

If the first device 300 wants to perform the provisioning procedure, however, that is, if the first device attempts to join a mesh network, the first device 300 transmits a capability message in response to the invite message (S9030).

The capability message may include information indicating whether the first device 300 supports the setting of a security algorithm, a public key, information indicating whether a value can be output to a user, and information indicating whether a value can be received from a user.

Exchanging Public Key Step

Thereafter, the second device 400 transmits a start message for a provisioning start to the first device 300 (S9040).

If a public key cannot be used using the out-of-band technology, the second device 400 and the first device 300 exchange public keys (S9050, S9060).

However, if a public key can be used using the out-of-band mechanism, the second device 400 may transmit an ephemeral public key to the first device 300 and read a static public key from the first device 300 using the out-of-band technology.

Thereafter, the second device 400 authenticates the first device 300 by performing an authentication procedure along with the first device 300 (S9070).

Distribution-of-Provisioning Data Step

When the first device 300 is authenticated, the second device 400 and the first device 300 calculate and generate a session key.

Thereafter, the second device 400 transmits provisioning data to the first device 300 (S9080).

The provisioning data may include an application key, a device key, a network key, IVindex, a unicast address, and so on.

The first device 300 that has received the provisioning data transmits a complete message in response to the provisioning data, and thus the provisioning procedure is terminated (S9090).

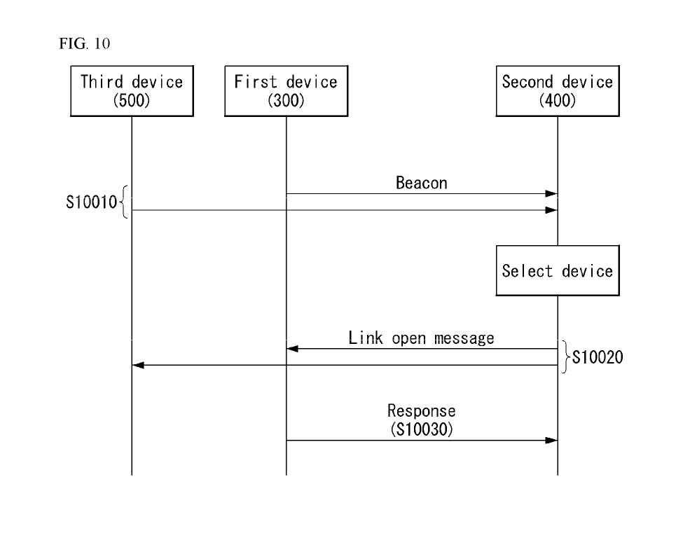

FIG. 10 is a flowchart illustrating an example of a bearer establishment procedure based on an advertisement to which the present invention may be applied.

Referring to FIG. 10, before performing a provisioning procedure with a new device (the first device 300), a provisioner (the second device 400) may establish an advertising-based bearer described in FIG. 8 above.

Particularly, the advertising-based bearer (hereinafter, referred to as a link) is established between the second device 400 and the first device 300 in order to transmit and receive messages of the provisioning procedure.

First, the first device 300 and a third device 500 that are devices not provisioning transmit a beacon message to the second device 400 (step, S10010).

At this time, the beacon message may be transmitted to neighboring devices including the second device 400 in the broadcast format, and may include a Universal Unique Identifier (UUID) of the device.

The second device 400 that performs the role of provisioning may receive the beacon message and may identify the device that transmits the beacon message through the UUID included in the beacon message.

The second device 400 may select the first device 300 as a device for performing the provisioning procedure among the identified devices based on a Received Signal Strength indicator (RSSI) and so on.

Later, the second device may transmit a link open message including the UUID and an ID of the established link of the selected first device 300 to the first device 300 and the second device 400 (step, S10020).

At this time, the link open message may be transmitted to the neighboring devices in the broadcast format.

The first device 300 that receives the link open message may know that it desires to form a link with the first device 300 itself through the UUID included in the link open message, and may transmit a response message including an ID of the link to the second device 400 in response (step, S10030).

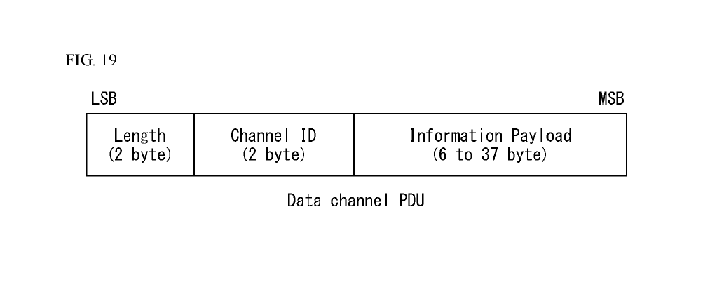

Through such a procedure, a link may be established between the second device 400 and the first device, and through the link which is established, the provisioning procedure described in FIG. 19 above may be performed.

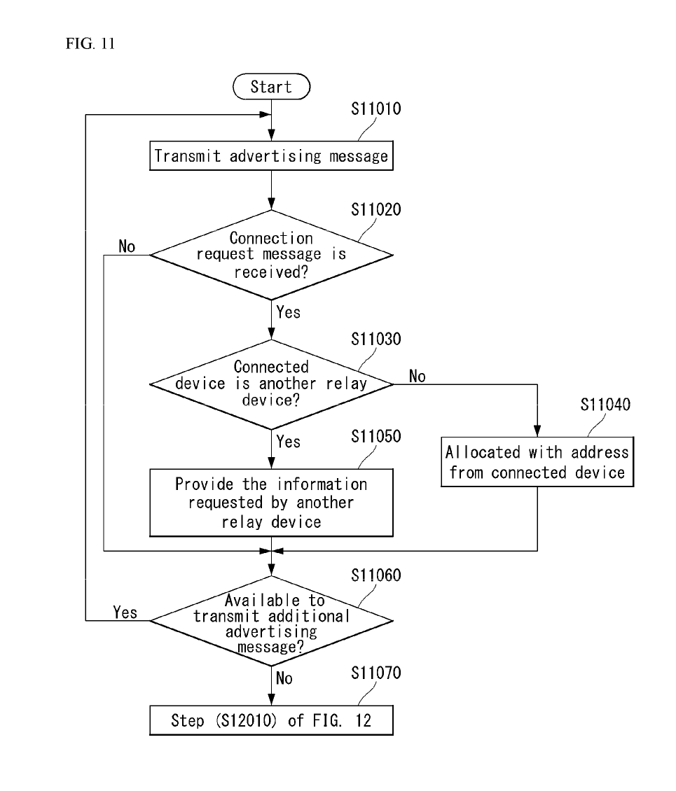

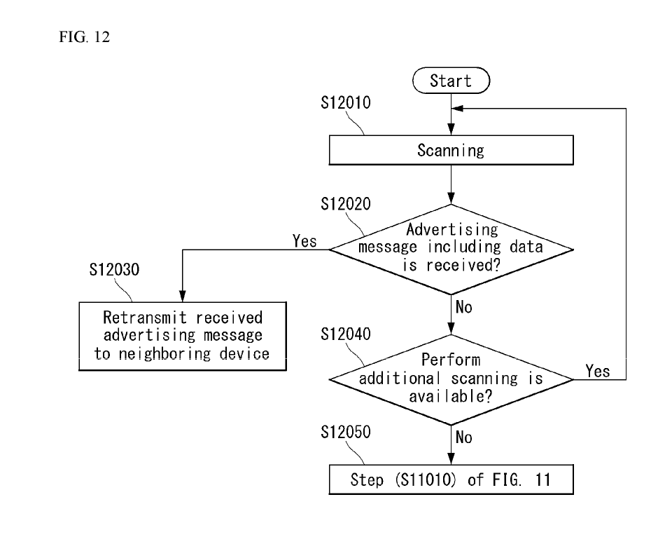

FIG. 11 and FIG. 12 are flowcharts illustrating an example of an operation of a relay device in a Bluetooth mesh network to which the present invention may be applied.

Referring to FIG. 11 and FIG. 12, in the Bluetooth mesh network, when a relay device receives a message from a neighboring device (an edge device or a relay device), the relay device transmits the received message to a neighboring device (an edge device or a relay device) again.

Particularly, the relay device transmits an advertising message in order to be connected with a neighboring relay device or edge device or transmit data (step, S11010). At this time, the advertising message may be transmitted through an advertising channel.

The expression of the advertising message is just an example, but also may be called an advertising message, an advertising PDU, an advertising packet, and so on.

In the case that a connection request message is not received in response to the advertising message (step, S11020), the relay device determines whether it is available to transmit an advertising message additionally (step, S11060).

In the case that it is available to transmit an additional advertising message, the relay device transmits the advertising message by returning to step, S11010.

However, in the case that it is not available to transmit an additional advertising message, as in step S12010, the relay device may scan messages transmitted from a neighbor by changing a mode to a scanning mode (step, S11070).

In the case that the connection request message is received in response to the advertising message (step, S11020), the relay device is connected with the device that transmits a connection message through a connection procedure.

In the case that the connected device is another relay device (step, S11030), the relay device may provide the information requested by another relay device (step, S11050).

However, in the case that the connected device is not another relay device (step, S11030), the relay device may be allocated with an address from the connected device (step, S11040).

Later, the delay device determines whether it is available to transmit an additional advertising message, and in the case that it is available to transmit an additional advertising message, the relay device returns to step S11010, and transmits the additional advertising message.

However, in the case that it is not available to transmit an additional advertising message, like step S12010 of FIG. 12, the relay device receives a message transmitted from a neighbor by changing a mode to a scanning mode (step, S12010).

In the case that an advertising message including data during the scanning procedure (step, S12020), the relay device performs a relay operation of retransmitting the advertising message to a neighboring device again (step, S12030).

However, in the case that the delay device fails to receive the advertising message during the scanning procedure (step, S12020), the relay device may determine whether to perform the scanning operation additionally (step, S12040).

In the case that the additional scanning operation is available, the relay device returns to step S12010, and performs the scanning operation.

However, in the case that the relay device is unable to perform the additional scanning operation, the relay device may return to the advertising mode and transmit an advertising message (step, S12050).

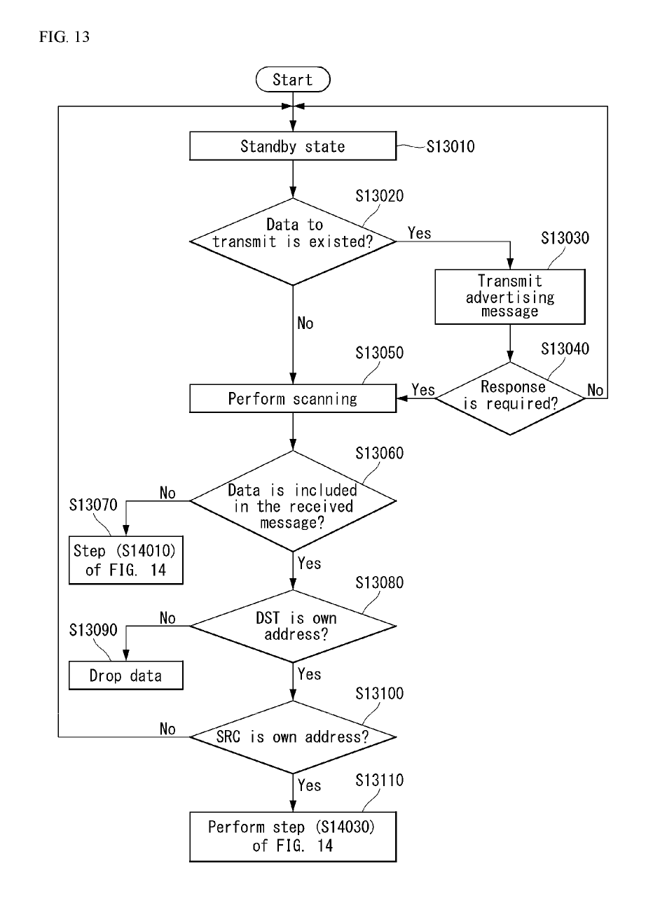

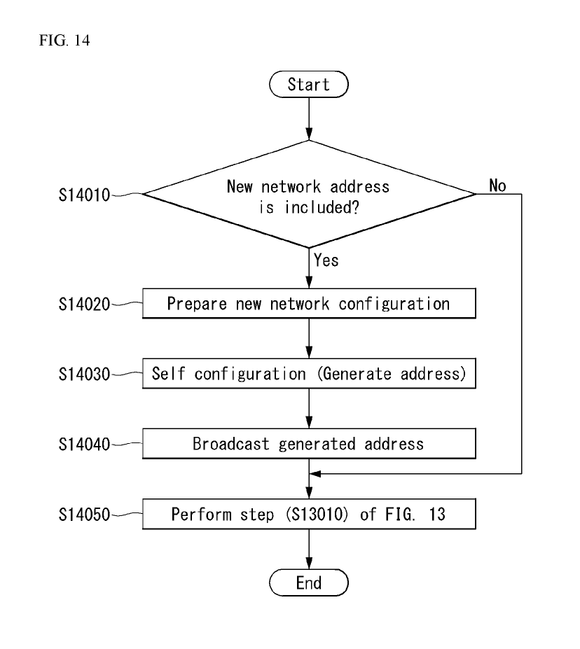

FIG. 13 and FIG. 14 are flowcharts illustrating an example of an operation of an edge device in a Bluetooth mesh network to which the present invention may be applied.

Referring to FIG. 13 and FIG. 14, in a Bluetooth edge network, an edge device may transmit and receive data to a relay device, and in the case of receiving data, the delay device may drop the data when a destination address is not its own address.

Particularly, the edge device is existed in a standby state, normally (step, S13010). In the standby state, the edge device does not transmit and receive any data.

Later, the edge device determines whether the data to transmit to other device is existed (step, S13020), and in the case that there is a data to transmit, the edge device enters an Advertising state and transmits an advertising message (step, S13030).

However, in the case that there is no data to transmit, the edge device enters a scanning state and performs the scanning in order to receive a message transmitted from other device (step, S13050).

In step S13030, the edge device transmits the data to transmit with being included in the advertising message to a neighboring relay device or edge device.

In the case that the data transmitted with being included in the advertising message does not require a response (step, S13040), the edge device enters the standby state again, and does not transmit and receive data (step, S13010).

However, in the case that the data transmitted with being included in the advertising message requires a response (step, S13040), the edge device enters the scanning state and performs the scanning in order to receive the response (step, S13050).

The edge device that enters the scanning state receives the message transmitted from other device, and determines whether a data is included in the received message (step, S13060).

In the case that the data is not included, the edge device may perform step, S14010) of FIG. 14. That is, by determining whether the message include a new network address (step, S14010), and in the case that the message does not include a new network message, the edge device enters the standby state as the step S13010 of FIG. 13 (step, S14050).

However, in the case that a new network address is included, the edge device prepares to configure a new network (step, S14020), and generate an address through the self configuration (step, S14030).

Later, the edge device broadcasts the generated address to other devices in the mesh network (step, S14040), and enters the standby stat again (step, S14050).

In the case that a data is included in the received message in step S13060), the edge device determines whether the value of Dst field representing a destination address of the data is its own address (step, S13080).

In the case that the value of Dst field is not its own address, the edge device drops the received message (step, S13090).

However, in the case that the value of Dst field is its own address, the edge device determines whether the value of SRC field that is a field representing an address of the device (source device) that transmits the message is its own address (step, S13100).

In the case that the value of SRC field does not represent its own address, the edge device enters the standby state again (step, S13010).

However, in the case that the value of SRC field is its own address, the edge device may perform step S14030 of FIG. 13. That is, the edge device generates an address through the self configuration (step, S14030).

Later, the edge device broadcasts the generated address to other devices in the mesh network (step, S13040), and enters the standby state again (step, S14050).

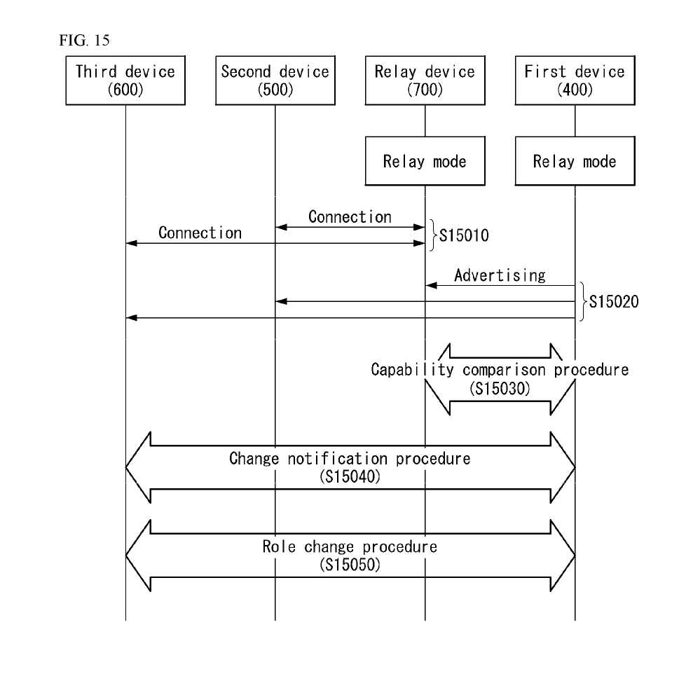

FIG. 15 is a flowchart illustrating an example of a method for changing a relay role between devices in a Bluetooth mesh network to which the present invention may be applied.

Referring to FIG. 15, the relay device may stop or continue the relay operation by comparing the capability of a new relay device in the case that the relay device approaches.

First, the first device 400, the second device 500, the third device 600 and the relay device 700 form a mesh network.

The relay device 700 and the first device 400 are in the Relay mode, and the second device 500 and the third device 600 are edge devices.

The relay mode may be configured by an initial configuration of a user, and is a mode entered when the Bluetooth function of the relay device is turned on.

When the relay devices receive a message in the relay mode, the relay devices perform a relay operation of retransmitting the message to other neighboring relay device or edge device.

The relay device 700 in the relay mode is connected with the second device 500 and the third device 600 through Bluetooth LE (step, S15010).

That is, the relay device 700 transmits an advertising message to the second device 500 and the third device 600.

The second device 500 and the third device 600 discover the relay device through the advertising message, and perform a connection procedure by transmitting a connection request message for a connection, and thus, the relay device establishes a connection with the second device 500 and the third device 600.

Later, a new relay device (hereinafter, the first device 400) approaches to the network, and transmits an advertising message for a connection with neighboring devices (step, S15020).

The relay device 700 that receives the advertising message performs a capability comparison procedure for changing a relay role with the first device 400, and determines which device is proper for the relay role (step, S15030).

In the case that the device performing the relay role is changed through the capability comparison procedure, the newly changed relay device is notified to neighboring devices (the second device 500 and the third device 600) (step, S15040).

However, in the case that the device performing the relay role is not changed, the change notification procedure is not performed.

Later, the role change procedure, the delay device 700 does not perform the relay operation any more, and the first device 400 is connected with the second device 500, the third device 600 and the relay device 700, and performs the relay operation (step, S15050).

Through such a method, the case that the number of relay nodes is excessively increased may be prevented, and there is an effect of decreasing the network traffic and collision owing to the relay operation.

In addition, it may be configured such that a device proper for the relay operation may perform the relay role.

Hereinafter, each procedure is described in detail.

<Capability Comparison Procedure>

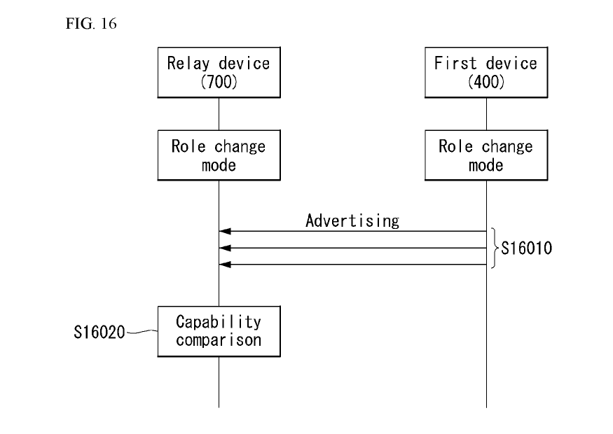

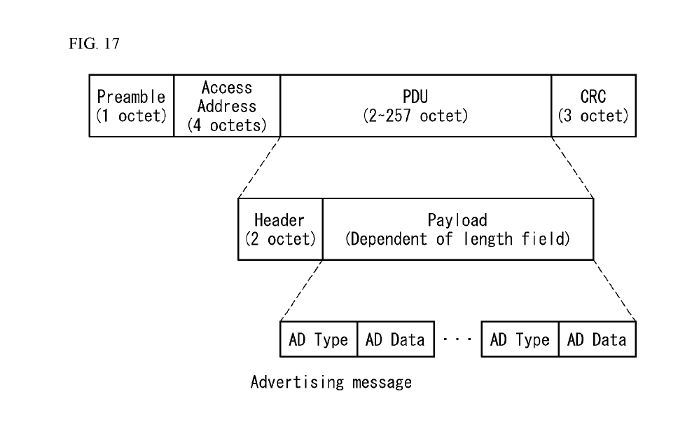

FIG. 16 and FIG. 17 are diagrams illustrating an example of a method for comparing capabilities between devices and a message format in a Bluetooth mesh network to which the present invention may be applied.

FIG. 16 above shows a detailed procedure in the case that the capability comparison procedure of FIG. 15 above is performed in a connection less state.

Particularly, the relay device 700 and the first device 400 enter a Role Change Mode such that the first device 400 performs a procedure for changing the role of transmitting an advertising message to the relay device 700.

The Role Change Mode means a mode in which a role change with a neighboring device is available in the case that there is a neighboring relay device.

In this case, the expression of the Role Change Mode is just an example, but may be used as other expression.

The first device 400 that enters the Role Change Mode transmits an advertising message (a first message) to the relay device for a capability comparison (step, S16010).

The advertising message is transmitted through a broadcast channel, and may have the format as shown in FIG. 17.

As shown in FIG. 17, the advertising message may include a Preamble field, an Access Address field, a Packet Data Unit field and a Cyclic Redundancy Check (CRC)

### FIELD

The Preamble field may have the value “10101010” or “01010101” of 8 bits, and may be used for performing frequency synchronization and a symbol timing evaluation in a receiver side.

The Access Address field may have a value of 32 bits, and may have a fixed value (e.g., 0x8E89BED6) of an Advertising Channel Packet.

The CRC field indicates a check value for checking whether there is an error in data when transmitting the data through a network. A CRC code of 24 bits may be inserted at an end of all link layer packets, and may be calculated based on a PDU field.

The PDU field may include a Header field and a Payload field.

The Header field is a field including information of the advertising message, and Table 2 below represents an example of the Header field.

TABLE 2

| | | | | | |
|---|---|---|---|---|---|
| PDU Type | Reserved | TxAdd | RxAdd | Length | Reserved |

The PDU Type field is a field that represents type information of the advertising message, and may represent whether the advertising message is an Advertising type, a Scanning type or an Initiating type.

The TxAdd field represents whether an address of the device that transmits the advertising message is public or random. For example, when the TxAdd value is ‘1’, this represents random, and when the TxAdd value is ‘0’, this represents public.

The RxAdd field represents whether an address of the device that receives the advertising message is public or random. For example, when the RxAdd value is ‘1’, this represents random, and when the RxAdd value is ‘0’, this represents public.

The Payload field may include a PDU Type field indicating a type of the PDU field and an AD data field in which a detailed data is included.

The first device 400 may transmit the Payload field with the capability information (first capability information) being included. For example, the AD Type field may represent a type of the capability information, and the AD Data field may represent a detailed value of the capability information.

In this case, the capability information may include a Received Signal Strength Indication, a battery remains or state, transmission strength (TX Power), reception strength (RX Power), and so on.

Table 3 below represents an example of the Payload field.

TABLE 3

| AD Type | AD Data |
|---|---|
| <<RSSI>> | 10 dBm, −20 dBm, etc. |
| <<Battery>> | Good, Bad, etc. |
| <<Tx Power>> | 20 dBm, etc. |
| <<Rx Power>> | 20 dBm, etc. |

The relay device that receives the advertising message may determine which device is proper for the relay role (e.g., whether the reception signal strength is higher or the battery state is better, etc.) by comparing the capability information included in the advertising message with its own capability information (second capability information) (step, S16020).

Through such a method, the relay device 700 may compare the capability of the first device 400, which is a new relay device, with its own capability.

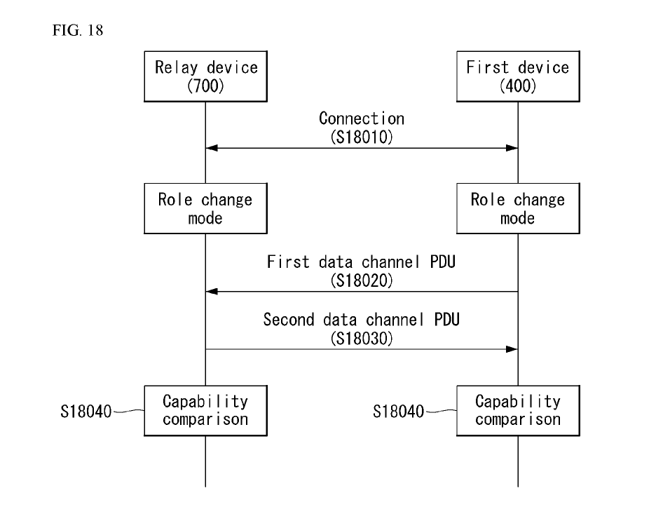

FIG. 18 and FIG. 19 are diagrams illustrating another example of a method for comparing capabilities between devices and a message format in a Bluetooth mesh network to which the present invention may be applied.

Referring to FIG. 18 and FIG. 19 above, different from FIG. 16 and FIG. 17 above, a detailed procedure is shown in the case that the capability comparison procedure is performed in a connection state.

In step S15020 of FIG. 15, the relay device 700 that receives the advertising message from the first device 400 may transmit a connection request message to the first device 400 and may be connected with the first device 400 by performing the connection procedure (step, S18010).

After the relay device 700 and the first device 400 are connected with each other, the relay device 700 and the first device 400 enter the Role Change Mode described in FIG. 15 above.

Later, the relay device receives a first data channel PDU (a first message) including the capability information (first capability information) of the first device 400 (step, S18020), and transmits a second data channel PDU (a second message) including the capability information (second capability information) of the relay device (step, S18030).

In this case, the first data channel PDU and the second data channel PDU may be configured with the format as shown in FIG. 19 above.

The Channel ID field is a field representing an ID of a channel through which the data channel PDU is transmitted.

The information payload field is a field in which a detailed data is included, and may include the capability information.

In this case, when a value of the channel ID field is set to 0x0004, the format of the information payload is configured as an attribute structure as represented in Table 4 below, and the data channel PDU may be transmitted and received by using the attribute structure.

TABLE 4

Attribute Handle (2 byte)
Attribute Type (2 byte or 16 byte)
Attribute Value (Fixed or Variable)
Attribute Permissions (GATT Profile)

The “Attribute Type” of Table 4 may include the same types of value as the AD Type of FIG. 16 above, and the “Attribute Value” may include the same types of value as the AD Data.

Later, the relay device 700 and the first device 400 may determine which device is proper for the relay role (e.g., whether the reception signal strength is higher or the battery state is better, etc.) by comparing the first capability information with the second capability information (step, S18040).

Change Notification Procedure and Role Change Procedure

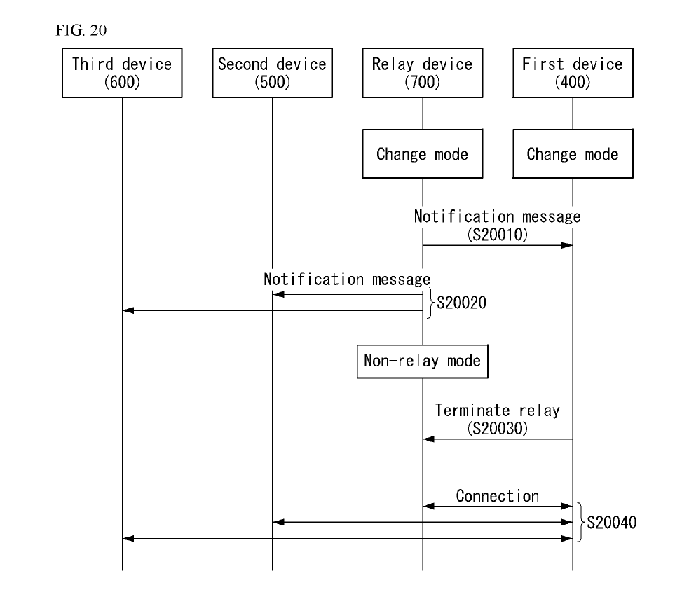

FIG. 20 is a flowchart illustrating an example for notifying a change of the relay role to devices in a Bluetooth mesh network to which the present invention may be applied.

Referring to FIG. 20, the relay device that determines a device proper for the relay role through the capability comparison procedure described from FIG. 15 to FIG. 18 notifies a type of the determined device to neighboring devices.

Particularly, the relay device that determines a device proper for the relay role through the capability comparison procedure described from FIG. 16 to FIG. 19 notifies the determined device to the first device 400, the second device 500 and the third device 600 through a notification message (steps, S20010 and S20020).

In the case that the capability of the relay device 700 is better as a result of the comparison, the relay device may continue to perform the relay role with being connected with the second device 500 and the third device 600, and the first device 400 enters a non-relay mode in which the relay role is not performed.

However, in the case that the capability of the first device 400 is better as a result of the comparison, after the relay device 700 transmits the notification message, the first device 400 terminates the connection with the second device 500 and the third device 600, and enters the non-relay mode.

Later, the first device 400 transmits a relay termination message notifying that the role of the relay device 700 is terminated to the relay device 700 (step, S20030).

The expression of the relay termination message is just an example, but may be referred to as other expression.

The relay device 700 that receives the relay termination message may perform the role of edge device that does not perform the relay role.

The second device 500 and the third device 600 in which the connection with the relay device 700 is terminated and the relay device 700 that performs the role of an edge device establish a connection with the first device 400 that newly performs the relay role (step, S20040).

Particularly, the relay device 700, the second device 500 and the third device 600 transmit an advertising message to the first device 400, and the first device transmits a connection request message to the relay device 700, the second device 500 and the third device 600, and thus a connection is established by performing the connection procedure.

Through the method described in FIG. 15 to FIG. 20, the remaining relay devices except optimal relay devices terminate the relay role, and thus, the number of relay devices may be decreased, and accordingly, there is an effect of decreasing network traffic and occurrence of collision.

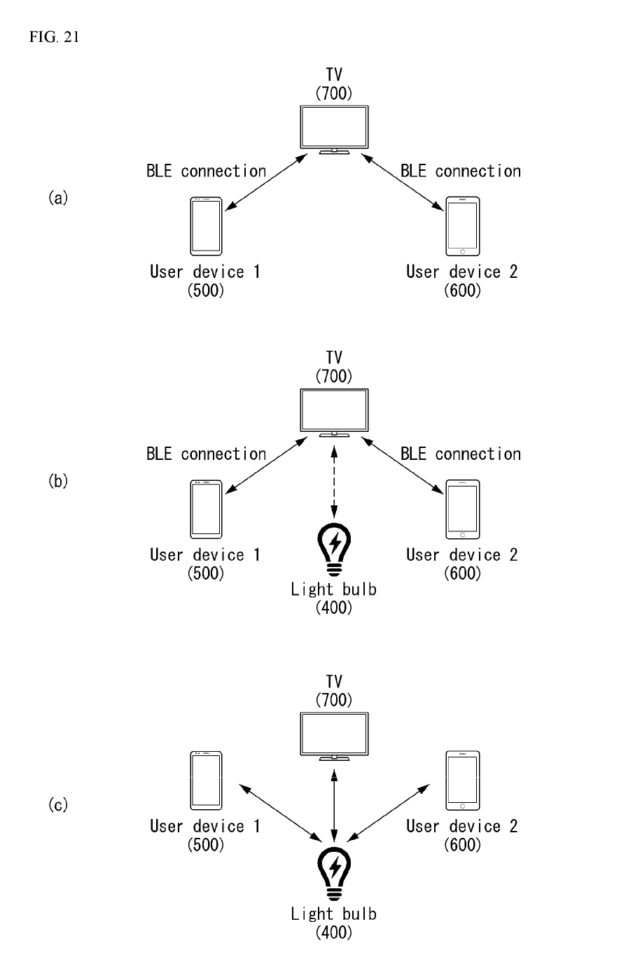

FIG. 21 is a diagram illustrating an example that the method for changing relay role in a mesh network is applied in real life to which the present invention may be applied.

Referring to FIG. 21, an example that the method described in FIG. 15 to FIG. 20 is used in real life is described.

Particularly, (a) a TV 700 which is a relay device, a first user device 500 which is an edge device and a second user device 600 establish a mesh network through Bluetooth LE.

In this case, when a light bulb 400 which is a new relay device joins in the mesh network, the TV 700 and the light bulb 400 perform the capability comparison procedure described in FIG. 14 to FIG. 19 above.

(b) As a result of the comparison, when the TV 700 is more proper for the relay role, the light bulb 400 performs the role of an edge device, does not perform the relay role.

However, in the case that the light bulb 400 is more proper for the relay role, the TV 700 notifies the fact to the first user device 500 and the second user device 600, and terminates the Bluetooth LE connection with the first user device 500 and the second user device 600.

(c) Later, the TV 700 performs the role of the edge device, does not perform the relay role.

In addition, the TV 700, the first user device 500 and the second user device 600 are connected with the light bulb 400 that newly performs the relay role through the Bluetooth LE.

The present invention described so far is not limited by the embodiments described above and the accompanying drawings since various substitutions, modifications and alterations of the present invention are available for those skilled in the art without departing from the inventive concept of the present invention.

Furthermore, for the convenience of description, the present invention is described with separate drawings, but it is also available to design to implement a new embodiment by combining the embodiments described in each drawing.

### INDUSTRIAL APPLICABILITY

The present specification relates to Bluetooth data transmission and reception, and more particularly, to a method and apparatus for transmitting a message between devices in a mesh network using Bluetooth Low Energy (LE) technique.

1. A method for changing a relay role performed by a relay device in a mesh network of Bluetooth, the method comprising:
receiving a first message including first capability information indicating a capability of a first device from the first device;
comparing the first capability information with second capability information indicating a capability of the relay device;
determining whether the first device performs a relay role based on the comparison result; and
transmitting a notification message including the comparison result to at least one device connected with the relay device.

2. The method of claim 1, further comprising transmitting a second message including the second capability information to the second device.

3. The method of claim 2, wherein the first message and the second message are transmitted through a data channel.

4. The method of claim 3, wherein each of the first message and the second message further includes a channel ID indicating the data channel.

5. The method of claim 4, wherein the first message and the second message are transmitted through an attribute protocol.

6. The method of claim 1, wherein the first message is transmitted through an advertising channel.

7. The method of claim 1, further comprising:
receiving a termination message indicating a termination of a relay role of the relay device from the first device, when the first device performs the relay role.

8. The method of claim 7, further comprising a connection termination procedure with the at least one device.

9. The method of claim 1, wherein each of the first capability information and the second capability information includes at least one of reception signal strength, battery remains information, transmission power information or a reception power information.

10. A method for performing a relay role performed by a first device in a mesh network of Bluetooth, comprising:
transmitting a first message including first capability information indicating a capability of the first device to a relay device performing a relay role;
receiving a second message including second capability information indicating a capability of the relay device from the relay device;
comparing the first capability information with the second capability information; and
determining whether the first device performs a relay role based on the comparison result.

11. The method of claim 10, further comprising transmitting a termination message indicating a termination of a relay role of the relay device to the relay device, when the first device performs the relay role.

12. The method of claim 11, further comprising performing a connection with at least one device which was connected with the relay device.

13. The method of claim 12, wherein performing the connection includes:
receiving an advertising message from the at least one device; and
transmitting a connection request message to the at least one device based on the advertising message.

14. The method of claim 10, wherein each of the first capability information and the second capability information includes at least one of reception signal strength, battery remains information, transmission power information or a reception power information.

15. A relay device for changing a relay role in a mesh network of Bluetooth, the relay device comprising:
a communication unit for communicating with a wired or wireless signal with exterior; and
a processor functionally connected with the communication unit, wherein the processor is configured to:
receive a first message including first capability information indicating a capability of a first device from the first device;
compare the first capability information with second capability information indicating a capability of the relay device;
determine whether the first device performs a relay role based on the comparison result; and
transmit a notification message including the comparison result to at least one device connected with the relay device.
